(19) United States
(12) Patent Application Publication
(10) Pub. No.: US 2006/0118594 A1
(43) Pub. Date: Jun. 8, 2006

(54) Nailing gun with improved nail magazine

(76) Inventor: Robert Chen, Tai-Ping City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/004,486

(22) Filed: Dec. 3, 2004

(51) Int. Cl. B25C 5/06

(52) U.S. Cl. 227/120; 227/109

(57) ABSTRACT

A nail magazine includes a magazine base which has a base panel, and first and second flanges projecting from and extending longitudinally at two opposite longitudinal ends of the base panel. A magazine cover includes a longitudinal cover panel, a third flange projecting from the cover panel adjacent the first flange and having a protrusion engaging slidably an engaging groove formed in an inner face of the first flange, a fourth flange projecting from the cover panel adjacent the second flange, and a limit member connected to the fourth flange. The limit member projects outwardly from the fourth flange and confines with the fourth flange a clamping groove to receive the second flange.

### BACKGROUND OF THE INVENTION

1. Field of the Invention

This invention relates to a nail gun for driving nails into an object, more particularly to an improvement relating to a nail magazine for receiving a nail stick.

2. Description of the Related Art

Referring to FIG. 1, a magazine for a nailing gun generally includes a magazine base 11 and a magazine cover 12. The magazine base 11 has a base panel 112 formed with a nail channel 111 and two upstanding walls 113 extending upward from the base panel 112 and having respective engaging grooves 114. The magazine cover 12 has a cover panel 121 formed with two opposite projections 122 to engage respectively the engaging grooves 114. By sliding the projections 122 along the engaging grooves 114 of the magazine base 11, the magazine cover 12 is positioned in the magazine base 11.

However, since the magazine cover 12 is confined by the upstanding walls 113, a much high accuracy is needed for the dimensions and positions of the projections 122 and the engaging grooves 114 in order to enable the projections 122 to slide properly in the respective engaging grooves 114. If the projections 122 are too tight in the engaging grooves 14, the sliding movement of the magazine cover 12 will be hindered. If the projections are too loose in the engaging grooves 14, the magazine cover 12 can slip from the magazine base 11. On the other hand, the need to provide high accuracy for the construction of the magazine increases the cost and time for manufacturing the nail gun.

### SUMMARY OF THE INVENTION

An object of the present invention is to provide a nailing gun with an improved nail magazine having a magazine base and a magazine cover that can interlock firmly and easily without the need for high dimensional and positional accuracy.

According to this invention, a nailing gun comprises a handle body, a barrel connected to one end of the handle body, a nail shooting nose connected to the barrel, a connecting unit connected to the other end of the handle body, and a nail magazine connected between the connecting unit and the nail shooting nose. The nail magazine includes a magazine base which includes a longitudinal base panel, and first and second flanges projecting from and extending longitudinally at two opposite longitudinal ends of the base panel, the first flange having an inner face formed with a longitudinal engaging groove. The nail magazine further comprises a magazine cover which includes a longitudinal cover panel, a third flange projecting from the cover panel adjacent the first flange and having a protrusion engaging slidably the engaging groove, a fourth flange projecting from the cover panel adjacent the second flange, a limit member connected to the fourth flange, and a clamping groove defined by the fourth flange and the limit member. The fourth flange and the limit member clamp the second flange in the clamping groove.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional nail magazine;

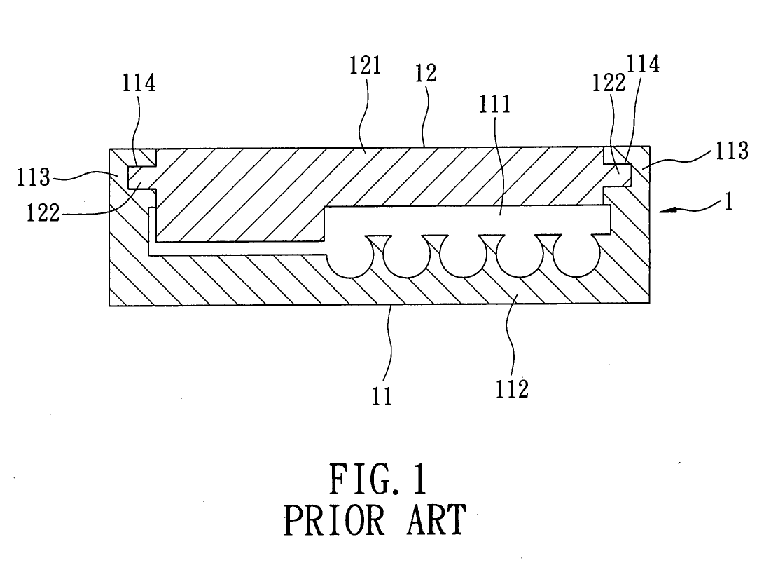

FIG. 2 is an elevation view of a nail gun embodying the present invention;

FIG. 3 is an exploded view of a nail magazine of the nail gun of FIG. 2;

FIG. 4 is the same view as FIG. 2 but with a nail magazine in an open state; and

FIG. 5 is a sectional view taken along line 5-5 of FIG. 4.

### DETAILED DESCRIPTION OF THE PREFERRED EMBODIMENT

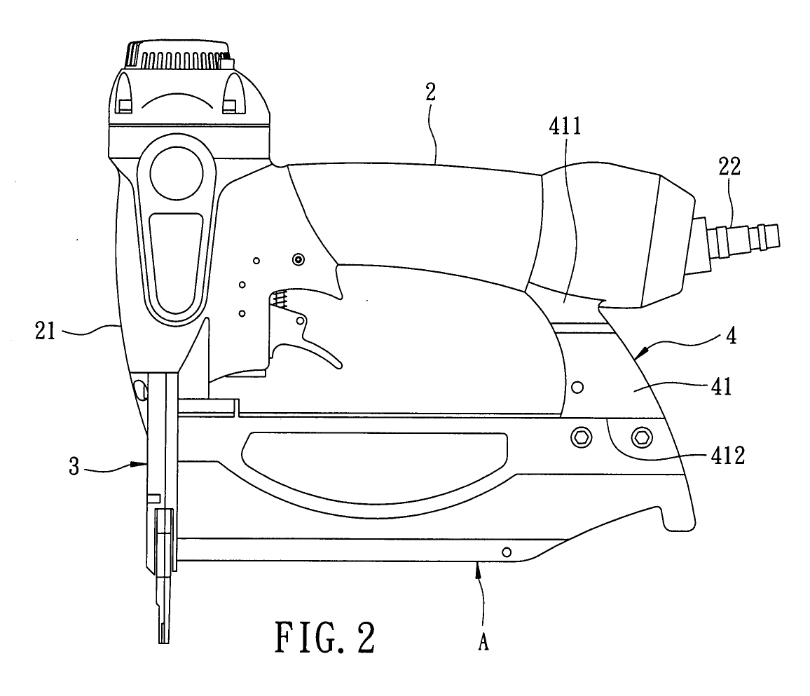

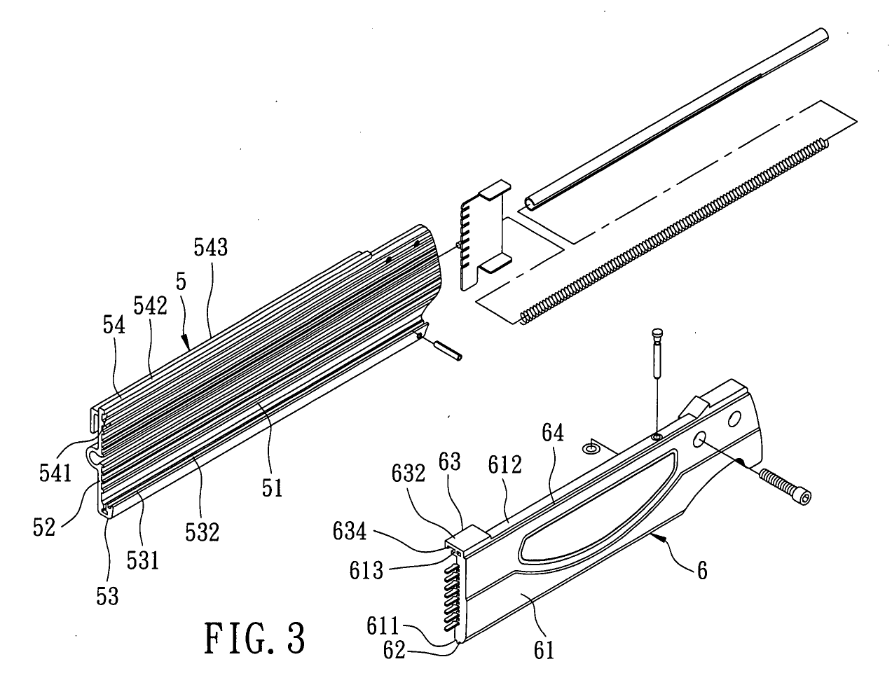

Referring to FIGS. 2 to 5, a nailing gun embodying the present invention includes a handle body 2 connected to a barrel 21 and an air hose 22. A nail magazine (A) has a rear end connected to the handle body 2 through a connecting unit 4, and a front end connected to a nail shooting nose 3.

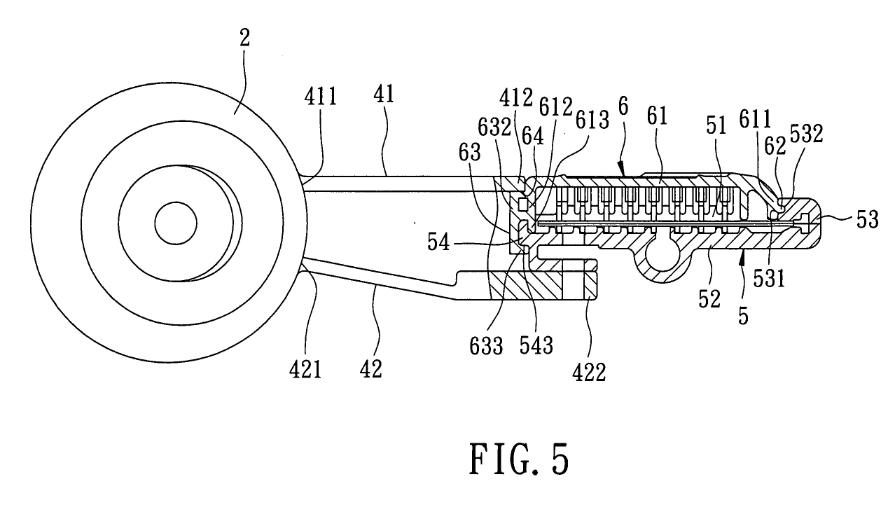

The connecting unit 4 has opposite first and second connecting plates 41 and 42 which have ends 411, 421 connected to the handle body 2 and ends 412 and 422 connected to the nail magazine (A) as shown in FIG. 5.

The nail magazine (A) includes a magazine base 5 and a magazine cover 6. The magazine cover 6 is connected to the first connecting plate 41, whereas the magazine base 5 is attached securely to the second connecting plate 42. The magazine base 5 has a base panel 52 which defines a nail channel 51, and first and second flanges 53 and 54 projecting from and extending longitudinally at two opposite longitudinal ends of the base panel 52. The first flange 53 has an inner face 531 formed with a longitudinal engaging groove 532. The second flange 54 has an inner face 541 and an outer face 542 opposite to the inner face 541.

The magazine cover 6 is coupled slidably to the magazine base 5 to close the nail channel 51 and includes a cover panel 61. The cover panel 61 has a longitudinal third flange 611 extending adjacent the first flange 53 of the base panel 52 and a protrusion 62 engaging slidably the engaging groove 532. The cover panel 61 further includes a longitudinal fourth flange 612 projecting from the cover panel 61 adjacent to the second flange 54, and a limit member 63 connected to the fourth flange 612.

The fourth flange 612 has a longitudinal terminating end 613. The limit member 63 projects outwardly from an outer face of the fourth flange 612 and confines with the fourth flange 612 a clamping groove 634 to receive the second flange 54. Preferably, the limit member 63 has a substantially L-shaped cross section and includes a first portion 632 which projects from the outer face of the fourth flange 612 and extends substantially along an extending direction of the terminating end 613 to a distance farther than the terminating end 613, and a second portion 633 bent inwardly from the first portion 632 at said farther distance and spaced apart from the terminating end 613. The clamping groove 634 is confined by the first and second portions 632 and 633 and the terminating end 613. The cover panel 61 further has a longitudinal shoulder 64 that extends in the outer face of the fourth flange 612 opposite to the terminating end 613. The first connecting plate 41 has its end 412 engaged slidably with the shoulder 64.

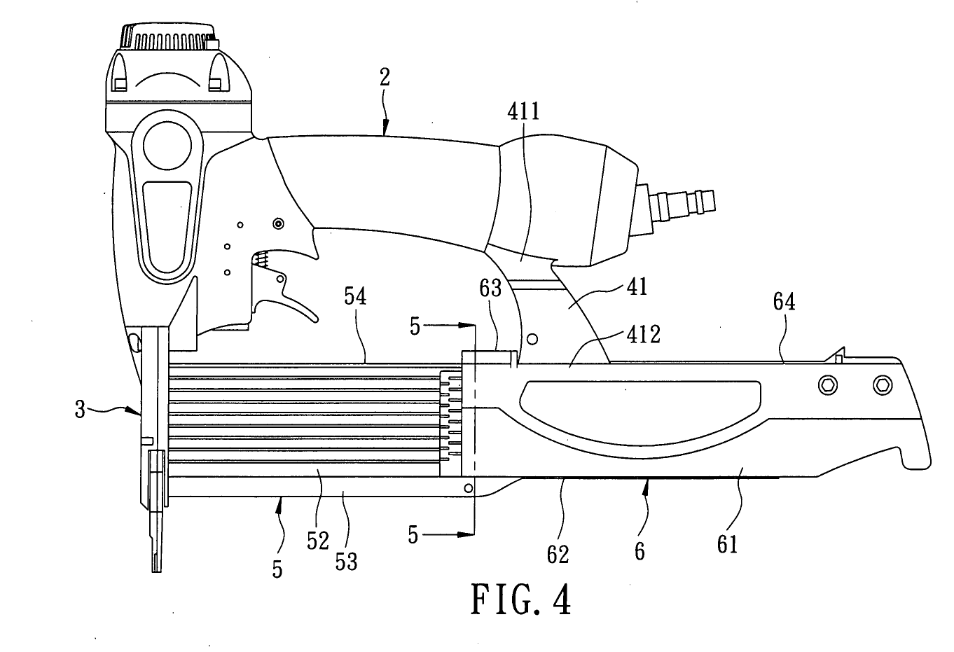

Referring once again to FIGS. 4 and 5, during assembly of the magazine cover 6 and the magazine base 5, the protrusion 62 of the third flange 611 is inserted into the engaging groove 532 of the first flange 53, the second flange 54 is inserted into the clamping groove 634 and between the second portion 633 of the limit member 53 and the terminating end 613, and the shoulder 64 is placed in engagement with the first connecting plate 41. At this stage, the third flange 611 is interlocked with and limited by the first flange 53, whereas the fourth flange 54 is clamped between the terminating end 613 and the limit member 63. A bottom end 543 of the second flange 54 of the base panel 52 is in abutment with the second portion 633 of the limit member 63. Furthermore, the first connecting plate 41 which engages the shoulder 64 presses the fourth flange 612 against the base panel 52.

Due to the provision of the limit member 63 and the shoulder 64, the magazine cover 6 can be slid over the magazine base 5 without slipping from the magazine base 5. In addition, since the limit member 63 extends only at the front end of the magazine cover 6 and has a measure of resiliency, the clamping groove 634 does not need high positional and dimensional accuracy but still can permit the second flange 54 to be easily inserted therein. As such, the nail magazine (A) according to the present invention can be produced with less accuracy in a less-complicated manner and hence the manufacturing cost thereof can be reduced.

While the present invention has been described in connection with what is considered the most practical and preferred embodiments it is understood that this invention is not limited to the disclosed embodiments but is intended to cover various arrangements included within the spirit and scope of the broadest interpretations and equivalent arrangements.

I claim:

1. A nailing gun comprising
a handle body,
a barrel connected to one end of said handle body,
a nail shooting nose connected to said barrel,
a connecting unit connected to the other end of said handle body, and
a nail magazine connected between said connecting unit and said nail shooting nose, said nail magazine including:
a magazine base which includes a longitudinal base panel, and first and second flanges projecting from and extending longitudinally at two opposite longitudinal ends of said base panel, said first flange having an inner face formed with a longitudinal engaging groove; and
a magazine cover including a longitudinal cover panel, a third flange projecting from said cover panel adjacent said first flange and having a protrusion engaging slidably said engaging groove, a fourth flange projecting from said cover panel adjacent said second flange, a limit member connected to said fourth flange, and a clamping groove defined by said fourth flange and said limit member, said fourth flange and said limit member clamping said second flange in said clamping groove.

2. The nail gun as claimed in claim 1, wherein said limit member is resilient and has a substantially L-shaped cross section.

3. The nail gun as claimed in claim 1, wherein said fourth flange has a terminating end, said limit member including a first portion which projects from said outer face of said fourth flange and which extends substantially along an extending direction of said terminating end, and a second portion bent inwardly from said first portion and spaced apart from said terminating end, said clamping groove being confined by said first and second portions and said terminating end.

4. The nail gun as claimed in claim 1, wherein said cover panel further includes a longitudinal shoulder that extends in said outer face of said fourth flange opposite to said terminating end.

5. The nail gun as claimed in claim 3, where in said connecting unit includes first and second connecting plates extending from said handle body to said nail magazine, said first connecting plate having one end engaging slidably said shoulder of said cover panel, said base panel being secured to said second connecting plate.

6. A nail gun comprising
a nail magazine which includes:
a magazine base which includes a longitudinal base panel, and first and second flanges projecting from and extending longitudinally at two opposite longitudinal ends of said base panel, said first flange having an inner face formed with a longitudinal engaging groove; and
a magazine cover including a longitudinal cover panel, a third flange projecting from said cover panel adjacent said first flange and having a protrusion engaging slidably said engaging groove, a fourth flange projecting from said cover panel adjacent said second flange, a resilient limit member connected to said fourth flange, and a clamping groove defined by said fourth flange and said limit member, said fourth flange and said limit member clamping said second flange in said clamping groove.

7. The nail gun as claimed in claim 6, wherein said limit member has a substantially L-shaped cross-section.

8. The nail gun as claimed in claim 6, wherein said fourth flange has a longitudinal terminating end, said limit member including a first portion which projects outward from said outer face of said fourth flange and which extends substantially along an extending direction of said terminating end to a distance farther than said terminating end.

9. The nail gun as claimed in claim 8, wherein said limit member further includes a second portion bent inwardly from said first portion at said distance and being spaced apart from said terminating end.
